(19) United States
(12) Patent Application Publication
(10) Pub. No.: US 2002/0147780 A1
(43) Pub. Date: Oct. 10, 2002

(54) Method and system for scanning electronic mail to detect and eliminate computer viruses using a group of email-scanning servers and a recipient's email gateway

(76) Inventors: James Y. Liu, Cupertino, CA (US); Jason Jinsong Liao, Cupertino, CA (US)

Correspondence Address: Bradley J. Bereznak, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/832,254

(22) Filed: Apr. 9, 2001

(51) Int. Cl. G06F 15/16

(52) U.S. Cl. 709/206; 709/246

(57) ABSTRACT

A system for scanning email messages to detect and eliminate viruses is disclosed. A recipient's email gateway receives email messages from a network. The email messages are transmitted by the recipient's email gateway to a group of email scannning servers connected to the network. The group of email-scanning servers comprises one or more email-scanning servers. Each of the email-scanning servers includes one or more anti-virus software to scan and clean viruses from the email messages to generate clean email messages. The clean email messages are transmitted by the group of email-scanning servers to the recipient's email gateway.

### FIELD OF THE INVENTION

The present invention relates to a method and system for scanning electronic mail (email) to detect and eliminate computer viruses. More particularly, the present invention relates to a method and system using a group of email-scanning servers to scan email messages and using a recipient's email gateway to transport the email messages to and from the group of email-scanning servers.

### BACKGROUND

Exchanging email is one of the most popular features on the Internet. Email can be exchanged with various people around the world, including friends, colleagues, family members, customers or even strangers on the Internet. Email is fast, easy, inexpensive and saves paper and telephone calls. However, email messages may contain malicious computer programs known as computer viruses. Opening an email message or attachment that contains computer viruses may cause computer security problems such as loss of data, loss of use, leakage of confidential information stored in the computer, loss of business, loss of profit and spread of computer viruses, among others.

There are currently several methods for virus detection in email messages. One method of detecting viruses in email messages involves using anti-virus software on each email recipient's computer when the email messages are retrieved or opened by the recipients. This method requires difficult tasks of installing anti-virus software and maintaining it on each email recipient's computer. Another method of detecting viruses in email messages involves scanning email messages using anti-virus software on the recipients' email servers when the email messages are being stored into the recipients' email boxes in the recipient's email servers. This method requires anti-virus software to be installed and maintained on the recipients' email servers.

Still another method involves changing the DNS (Domain Name System) of the recipients' Internet domain to redirect email messages to an email-scanning server before the email messages are transferred to the recipients' email servers. In the DNS of the recipient's Internet domain name, a MX (Mail Exchanger) DNS resource record points to the recipient's email server, or the best path to the recipient's email server. This method requires the DNS of the recipient's Internet domain name to be modified so that the MX DNS resource record can be replaced. Modifying the DNS of a recipient's Internet domain name is difficult because multiple parties (e.g., owner of the Internet domain name, ISP (Internet Service Provider) that provides the DNS service, ASP (Application Service Provider) that provides email-scanning service, etc.) are involved. Sometimes it is almost impossible to modify the DNS for an email recipient. It is generally impossible to modify the DNS of the Internet domain name of the email service provider upon the request of the recipient because modifying the DNS of the service provider's Internet domain name will affect all subscribers of the service provider.

Thus, there are many limitations, disadvantages and drawbacks in the existing email virus detection methods including high cost, implementation and maintenance difficulty, inadequate protection, etc. Accordingly, there is a need for a more efficient and easier-to-deploy method and system for scanning email messages to provide better protection against computer viruses.

### SUMMARY OF THE INVENTION

In one embodiment, a system for scanning email messages to detect and eliminate computer viruses is disclosed. A recipient's email gateway receives email messages from a network. The email messages are transmitted by the recipient's email gateway to a group of email-scanning servers connected to the network. The group of email-scanning servers comprises one or more email-scanning servers. Each of the email-scanning servers includes one or more anti-virus software to scan and clean viruses from the email messages to generate clean email messages. The clean email messages are transmitted by the group of email-scanning servers to the recipient's email gateway where they can be retrieved by the recipient. Notification may be generated when a virus is detected. The recipient's email gateway may include email server functions.

Other objects, features and advantages of the present invention will be apparent from the accompanying drawings and from the detailed description which follows.

### BRIEF DESCRIPTION OF THE DRAWINGS

The present invention is illustrated by way of example in the following drawings in which like references indicate similar elements. The following drawings disclose various embodiments of the present invention for purposes of illustration only and are not intended to limit the scope of the invention.

FIG. 1 is an exemplary illustration of a group of email-scanning servers according to the present invention.

FIG. 2 is a flow diagram illustrating an exemplary email-scanning process performed by a group of email-scanning servers.

FIG. 3 is an exemplary network diagram illustrating one embodiment of an email scanning system including a group of email-scanning servers and a recipient's email gateway.

FIG. 4 is an exemplary flow diagram illustrating an email scanning process for a system having a group of email-scanning servers and a recipient's email gateway.

FIG. 5 is an exemplary network diagram illustrating one embodiment of an email scanning system including a group of email-scanning servers, a recipient's email gateway and an email server.

FIG. 6 is an exemplary flow diagram illustrating an email scanning process for a system having a group of email-scanning servers, a recipient's email gateway and an email server.

FIG. 7 is an exemplary network diagram illustrating one embodiment of an email scanning system including a group of email-scanning servers, a recipient's email gateway and a service provider's email server.

FIGS. 8A and 8B are exemplary flow diagrams illustrating email scanning processes for a system having a group of email-scanning servers, a recipient's email gateway and a service provider's email server.

FIG. 9 is an exemplary network diagram illustrating one embodiment of an email scanning system including a group of email-scanning servers and a recipient's email gateway using dynamic IP addressing.

FIG. 10 is an exemplary flow diagram illustrating one embodiment of an email scanning process using a system including a group of email-scanning servers and a recipient's email gateway having a dynamic IP address.

### DETAILED DESCRIPTION OF THE INVENTION

A method and system for scanning electronic mail (email) to detect and eliminate computer viruses are disclosed. In one embodiment, incoming email messages are scanned and cleaned by a group of email-scanning servers to detect and eliminate viruses.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art.

The present invention also relates to system for performing the operations herein. This system may be specially constructed for the required purposes, or it may comprise a general-purpose computer selectively activated or reconfigured by a computer program stored in the computer.

The algorithms and displays presented herein are not inherently related to any particular computer or other system. Various general-purpose systems may be used with programs in accordance with the teachings herein, or it may prove convenient to construct more specialized system to perform the required method processes. The required structure for a variety of these systems will appear from the description below. The present invention is described using Internet protocols and Internet network; however, it will be appreciated that other network types and protocols may also be used. In addition, the present invention is not described with reference to any particular programming language. It will be appreciated that a variety of programming languages may be used to implement the teachings of the invention as described herein.

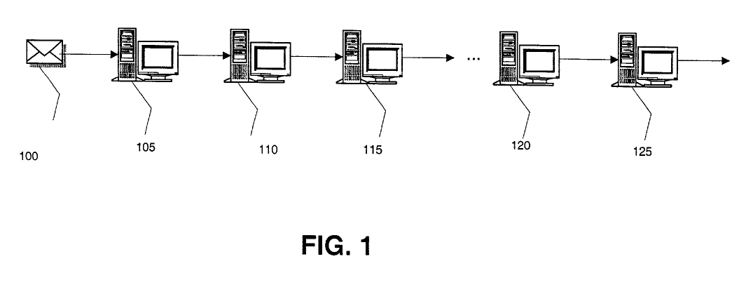

FIG. 1 is an exemplary illustration of a group of email-scanning servers according to the present invention. Generally, incoming email messages 100 are first received at incoming email server 105. In one embodiment, when the incoming email server 105 receives the incoming email message 100, the incoming email server 105 forwards the incoming email message to a first email-scanning server 110. Alternatively, the incoming email server 105 may be configured to check the headers of the incoming email messages 100 to determine if a recipient of the incoming email message 100 is a subscriber to an anti-virus cleaning service. If the recipient is not a subscriber, the incoming email message 100 may have reached the incoming email server 105 in error. In this situation, the incoming email message 100 may be bounced back to its sender. If the recipient is a subscriber, the incoming email message 100 is then forwarded to the first email-scanning servers 110.

There may be one email-scanning server configured with anti-virus software from one or more software vendors. Alternatively, there may be a group of multiple email-scanning servers each configured with one or more anti-virus software from multiple software vendors. For example, referring to FIG. 1, the group of email-scanning servers may include email-scanning servers 110, 115, 120 for scanning and cleaning.

The anti-virus software on each of the email-scanning servers 110, 115, 120 is maintained and updated regularly to provide the most up-to-date anti-virus protection. Each of the email-scanning servers 110, 115, 120 is configured to forward the incoming email message 100 to a next email-scanning server in the group. After the incoming email message 100 are scanned and cleaned by a last email-scanning server (e.g., email-scanning server 120), the incoming email message 100 is forwarded to an outgoing email server 125. The outgoing email server 125 is in charge of relaying the clean email message to its recipient.

In one embodiment, functions of the incoming email server 105 may be incorporated into the email-scanning server 110. In another embodiment, functions of the outgoing email server 125 may be incorporated into the email-scanning server 120. In another embodiment, the functions of the incoming email server 105 and the functions of the outgoing email server 125 may be incorporated into one email-scanning server.

When a virus is detected by an email-scanning server, virus notifications may be generated. For example, the virus notifications may be sent to the sender and recipient of the incoming email message 100. The virus notifications may also be sent to an email network administrator. Note that there may be situations when a virus is detected but cannot be cleaned. In this situation, appropriate virus notifications may also be generated. The incoming email messages are referred to herein generally as email messages.

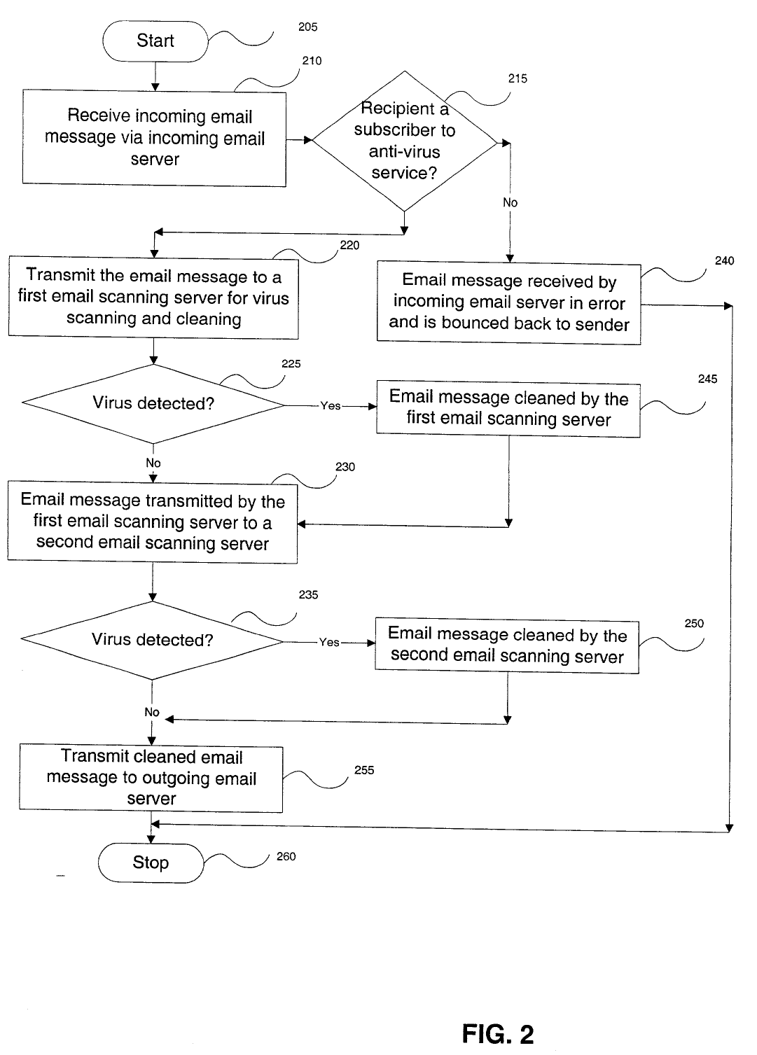

FIG. 2 is a flow diagram illustrating an embodiment of a virus detecting and cleaning process performed by a group of email-scanning servers. Although the process is described with two email-scanning servers, one skilled in the art would recognize that the process might be used with one email-scanning server or with more than two email-scanning servers. The process starts at block 205. At block 210, an incoming email message is received at the incoming email server. At block 215, a determination is made to see if the recipient of the email message is a subscriber to the anti-virus service. When the recipient is not a subscriber, the email message has reached the incoming email server in error and is bounced back to the sender, as shown in block 240.

When the recipient is a subscriber, the email message is transmitted to a first email-scanning server in a group of email-scanning servers to scan and clean the email message, as shown in block 220. At block 225, a determination is made to see if the first email-scanning server detects a virus. If a virus is detected by the first email-scanning server, the email message is cleaned, as shown in block 245, and the process continues at block 230. From block 225, if no virus is detected, the email message is transmitted by the first email-scaning server to a second email-scanning server, as shown in block 230. At block 235, a determination is made to see if the second email-scanning server detects a virus. If a virus is detected by the second email-scanning server, the email message is cleaned, as shown in block 250, and the process continues at block 255. From block 235, if no virus is detected, the process moves to block 255 where the cleaned email message is transmitted by the second email-scanning server to an outgoing email server. The process ends at block 260.

Although the process in FIG. 2 is described with an incoming email server and an outgoing email server, functions of these two servers may be incorporated into the email-scanning servers, as described above. Furthermore, the process may bypass determining if the recipient is a subscriber to the anti-virus service and instead move from block 210 directly to block 220.

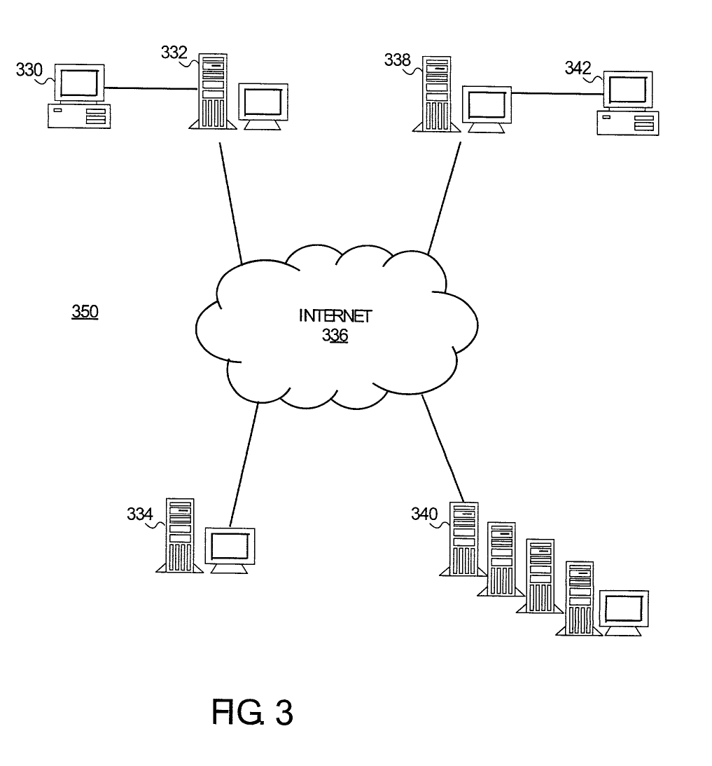

FIG. 3 is an exemplary network diagram illustrating one embodiment of an email scanning system including a group of email-scanning servers and a recipient's email gateway. Network 350 may include local area networks (LAN) and wide area networks (WAN). Network 350 may include multiple connected computer devices to facilitate transmitting email messages from the senders to the recipients. In one embodiment, the WAN is the Internet and simple mail transfer protocol (SMTP) is used to send and receive email messages.

Referring to FIG. 3, when an email message is sent by a sender from sending device 330 to a recipient at receiving device 342, the email message is first sent to sender's email server 332 using SMTP. The email message may include an email address in the header of the email message identifying the recipient. The sender's email server 332 may be operated and/or owned by the sender, an Internet service provider (ISP), a commercial online service (e.g. AOL, CompuServe, etc.) or any other service providers. The sender's email server 332 may make a Domain Name System (DNS) query using DNS server 334 via the Internet 336 to determine the Internet protocol (IP) address of the recipient's email gateway 338. The sender's email server 332 uses the Internet domain name in the recipient's email address to perform the DNS query.

When the IP address of the recipient's email gateway 338 is determined, the sender's email server 332 establishes a transmission control protocol (TCP) connection with the recipient's email gateway 338 via the Internet 336. When this connection is made, the email message is transmitted from the sender's email server 332 to the recipient's email gateway 338 using SMTP. The email message may travel through various routers (not shown) on the Internet 336 before arriving at the recipient's email gateway 338.

In one embodiment, the recipient's email gateway 338 determines if the email message needs to be scanned for virus detection and cleaning. The recipient's email gateway 338 may include software that automatically checks the source of the email message. If the email message is received from sources other than the group of email-scanning servers 340, then the email message needs to be scanned. Alternatively, if the source of the email message is the group of email-scanning servers 340, then the email message has already been scanned and cleaned. In another embodiment, the software may automatically check the header of the email message. If the header does not contain a status code, which indicates that the email message is free of virus, the email message needs to be sent to the group of email-scanning servers 340 to be scanned and cleaned.

In one embodiment, the recipient's email gateway 338 may use a pre-configured IP address to locate the group of email-scanning servers 340. Alternatively, the recipient's email gateway 338 may use DNS to query the DNS server 334 for the IP address of the group of email-scanning servers 340. Once the recipient's email gateway 338 locates the group of email-scanning servers 340, it establishes a TCP connection and uses SMTP to transmit the incoming email message to the group of email-scanning servers 340.

The group of email-scanning servers 340 may be connected to the Internet 336 via any type of Internet connection provided by, for example, an ISP, co-location service provider and the like. When the group of email-scanning servers 340 receives the email message transmitted by the recipient's email gateway 338, the email message is scanned and cleaned as described above. In one embodiment, the group of email-scanning servers 340 may add a status code to the header of the scanned and cleaned email message to indicate that the email message is free of virus. The status codes may also indicate that a virus was detected so that notification messages can be sent. For example, notification messages may be sent to the sender and to the recipient. The notification messages may also be sent to the email administrator. The notification messages may be used to locate the source of the virus to eliminate it. The group of email-scanning servers 340 then transmits the scanned and cleaned email message back to the recipient's email gateway 338. The IP address of the recipient's email gateway 338 may be obtained when the recipient's email gateway 338 makes a connection to the group of email-scanning servers 340. Alternatively, the IP address of the recipient's email gateway 338 may be obtained using a DNS query.

When the recipient's email gateway 338 receives the scanned and cleaned email message from the group of email-scanning servers 340, the recipient's email gateway 338 determines that the email message is free of virus by checking the source of the email message or the status code in the header of the email message. The recipient's email gateway 338 includes a Post Office Protocol (POP) and/or Internet Message Access Protocol (IMAP) server so that virus-free email messages can be stored therein until the recipient at the device 342 requests the virus-free or clean email message. When such request is made, the recipient at the device 342 retrieves the virus-free email message from the recipient's email gateway 338. One skilled in the art would recognize that other mail server protocols may also be used.

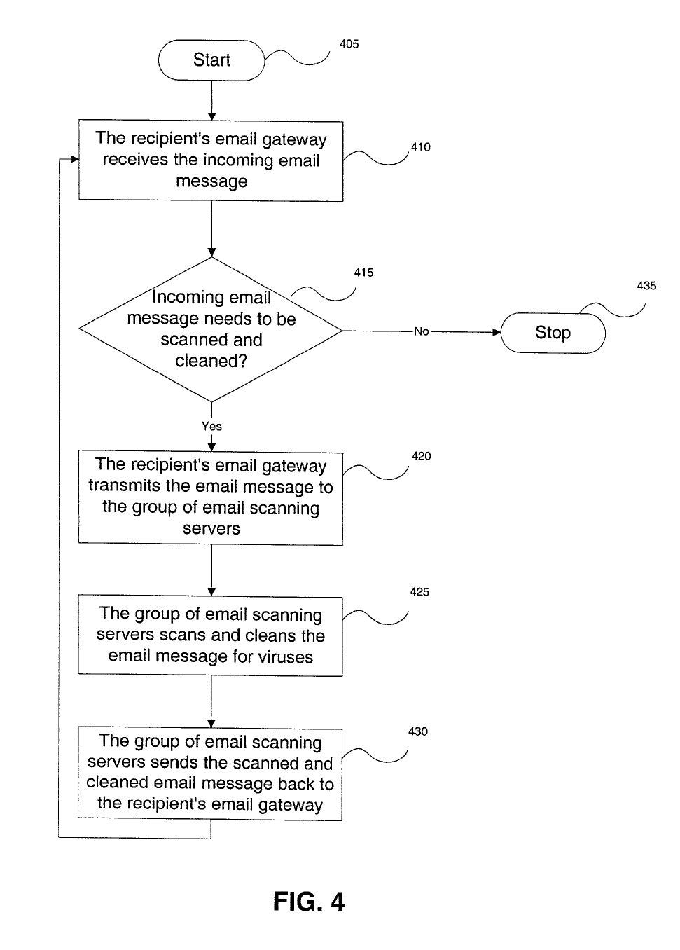

FIG. 4 is an exemplary flow diagram illustrating an email scanning process for a system having a group of email-scanning servers and a recipient's email gateway. In this embodiment, the recipient's email gateway has email server functions. The email scanning process may be performed using the system as described in FIG. 3. The process starts at block 405. At block 410, the recipient's email gateway receives the email message. At block 415, a determination is made to see if the email message needs to be scanned and cleaned of potential viruses. As described above, the determination may be made by software resident in the recipient's email gateway based on the source of the incoming email message, or a status code in the header of the email message.

If the email message comes from the group of email-scanning servers or if the header of the email message contains a status code indicating that the email message is free of virus, the email message is stored in the recipient's email gateway and the process stops at block 435. However, if the email message comes from sources other than the group of email-scanning servers, or it does not contain a status code indicating that it is free of virus, the recipient's email gateway transmits the email message to the group of email-scanning servers, as shown in block 420. At block 425, the email message is scanned and cleaned by the group of email-scanning servers. At block 430, the scanned and cleaned email message is sent back to the recipient's email gateway. The recipient's email gateway receives the scanned and cleaned email message at block 410. This time, since the email message is cleaned, it does not need to be cleaned again and the process flows from block 415 to block 435. The process stops at block 435.

Note the operation performed in block 425 may include verification to see if the recipient is a subscriber to the virus scanning and cleaning service. This operation may be similar to the process described in FIG. 2. If the recipient is not a subscriber, then the email message reached the email server in error, and the email message may be bounced back to the sender. However, if the recipient is a subscriber, the email message is sent to a first email-scanning server in the group of email-scanning servers. Alternatively, it may not be necessary for the group of email-scanning servers to perform subscriber verification. For example, the subscriber verification may have already been done elsewhere (e.g., the recipient's email gateway).

As can be appreciated, the system and method described in FIG. 3 and in FIG. 4 follow standard email protocols until email messages have reached the recipient's email gateway and thus can be easily implemented with minimal modification to the hardware and/or software of the sender's email server and the DNS server. In addition, using the group of email-scanning servers, numerous recipient email gateways can be supported to provide virus scanning and cleaning service.

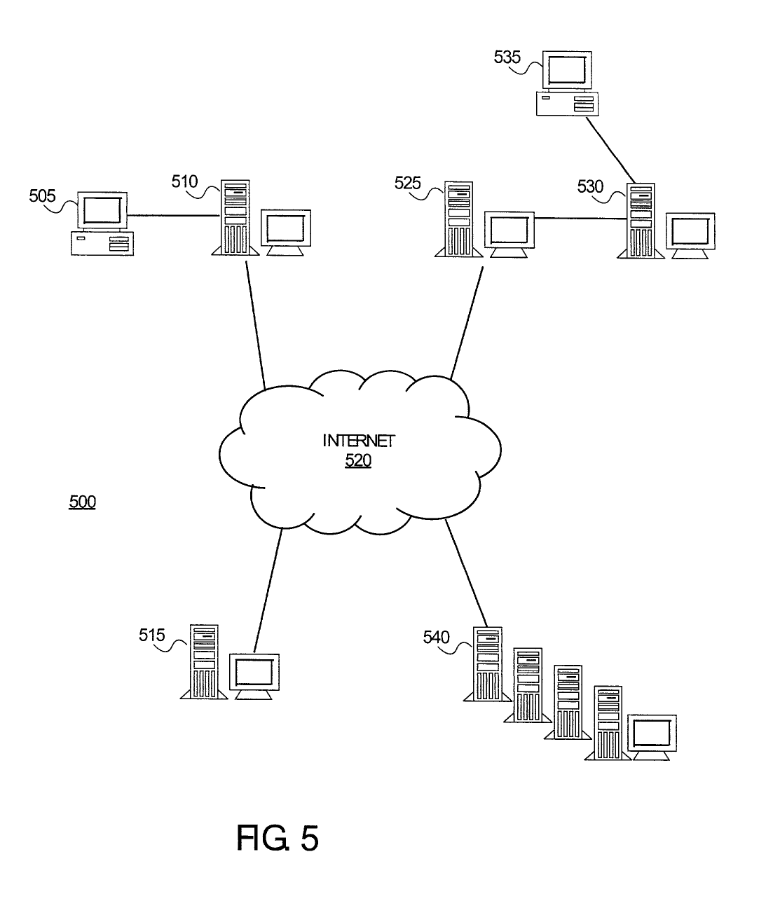

FIG. 5 is an exemplary network diagram illustrating one embodiment of an email scanning system including a group of email-scanning servers, a recipient's email gateway and an email server. Referring to FIG. 5, when an email message is sent by a sender from sending device 505 to a recipient at receiving device 535, the email message is first sent to sender's email server 510 using SMTP. The email message includes an email address in the email header identifying the recipient. The sender's email server 510 may be operated and/or owned by the sender, an ISP, a commercial online service (e.g. AOL, CompuServe, etc.) or any other service providers. The sender's email server 510 may make a DNS query using DNS server 515 via the Internet 520 to determine the IP address of the recipient's email gateway 525. The sender's email server 510 uses the Internet domain name in the recipient's email address to perform the DNS query.

When the IP address of the recipient's email gateway 525 is determined, the sender's email server 510 establishes a TCP connection with the recipient's email gateway 525 via the Internet 520. When this connection is made, the email message is transmitted from the sender's email server 510 to the recipient's email gateway 525 using SMTP. The email message may travel through various routers (not shown) on the Internet 520 before arriving at the recipient's email gateway 525.

In one embodiment, the recipient's email gateway 525 determines if the email message needs to be scanned for virus detection and cleaning. The recipient's email gateway 525 may include software that automatically checks the source of the email message. If the email message is received from sources other than the group of email-scanning servers 540, then the email message needs to be scanned. Alternatively, if the source of the email message is the group of email-scanning servers 540, then the email message has already been scanned and cleaned. In another embodiment, the software may automatically check the header of the email message. If the header does not contain a status code which indicates that the email message is free of virus, the email message needs to be sent to the group of email-scanning servers 540 to be scanned and cleaned.

In one embodiment, the recipient's email gateway 525 may use a pre-configured IP address to locate the group of email-scanning servers 540. Alternatively, the recipient's email gateway 525 may use DNS to query the DNS server 515 for the IP address of the group of email-scanning servers 540. Once the recipient's email gateway 525 locates the group of email-scanning servers 540, it establishes a TCP connection and uses SMTP to transmit the incoming email message to the group of email-scanning servers 540.

The group of email-scanning servers 540 may be connected to the Internet 520 via any type of Internet connection provided by, for example, an ISP, co-location service provider and the like. When the group of email-scanning servers 540 receives the email message transmitted by the recipient's email gateway 525, the email message is scanned and cleaned as described above. In one embodiment, the group of email-scanning servers 540 may add a status code to the header of the scanned and cleaned email message to indicate that the email message is free of virus. The group of email-scanning servers 540 then transmits the scanned and cleaned email message back to the recipient's email gateway 525. The IP address of the recipient's email gateway 525 may be obtained when the recipient's email gateway 525 makes a connection to the group of email-scanning servers 540. Alternatively, the IP address of the recipient's email gateway 525 may be obtained using a DNS query.

When the recipient's email gateway 525 receives the scanned and cleaned email message from the group of email-scanning servers 540, the recipient's email gateway 525 determines that the email message is free of virus by checking the source of the email message or the status code in the header of the email message. The status codes may also indicate that a virus was detected so that notification messages can be sent. For example, notification messages may be sent to the sender and to the recipient. The notification messages may also be sent to the email administrator. The notification messages may be used to locate the source of the virus to eliminate it. The recipient's email gateway 525 then transmits the clean email message to the recipient's email server 530, which usually includes a POP and/or IMAP server to store the clean email message. The clean email message can then be accessed by the recipient from receiving device 535.

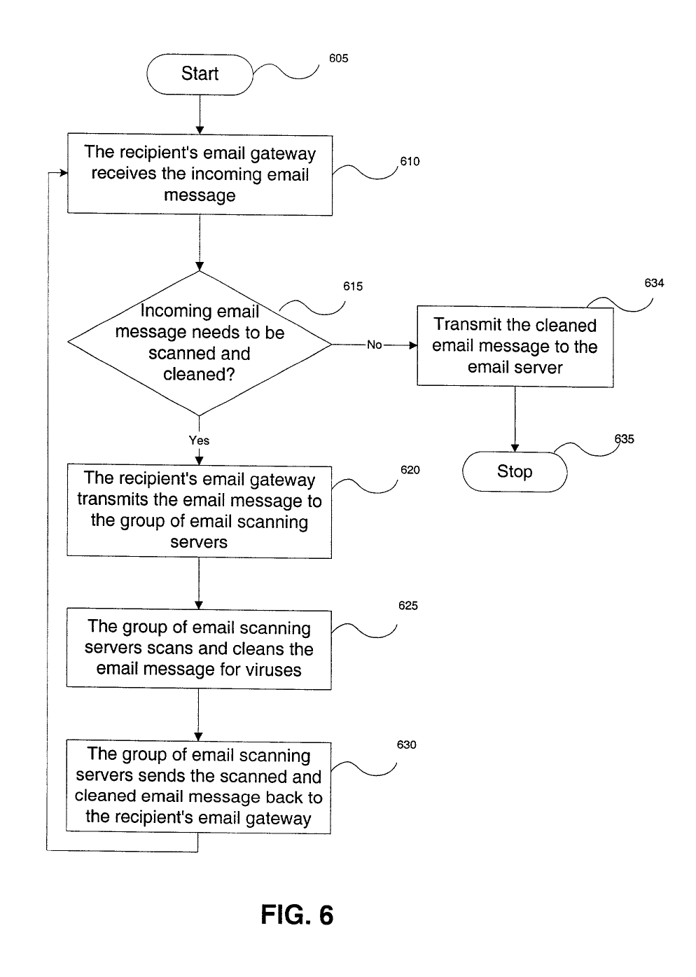

FIG. 6 is an exemplary flow diagram illustrating an email scanning process for a system having a group of email-scanning servers, a recipient's email gateway and an email server. The email scanning process may be performed using the system as described in FIG. 5. The process starts at block 605. At block 610, the recipient's email gateway receives the email message. At block 615, a determination is made to see if the email message needs to be scanned and cleaned of potential viruses. As described above, the determination may be made by software resident in the recipient's email gateway based on the source of the incoming email message, or a status code in the header of the email message.

If the email message comes from the group of email-scanning servers or if the header of the email message contains a status code indicating that the email message is free of virus, the email message is transmitted by the recipient's email gateway to the email server, as shown in block 634, and the process stops at block 635. However, if the email message comes from sources other than the group of email-scanning servers, or it does not contain a status code indicating that it is free of virus, the recipient's email gateway transmits the email message to the group of email-scanning servers, as shown in block 620. At block 625, the email message is scanned and cleaned by the group of email-scanning servers.

The operation performed in block 625 may include verification to see if the recipient is a subscriber to the virus scanning and cleaning service. This operation may be similar to the process described in FIG. 2. If the recipient is not a subscriber, the email message reached the email server in error, and the email message may be bounced back to the sender. However, if the recipient is a subscriber, the email message is sent to a first email-scanning server in the group of email-scanning servers. Alternatively, it may not be necessary for the group of email-scanning servers to perform subscriber verification. For example, the subscriber verification may have already been done elsewhere (e.g., the recipient's email gateway).

At block 630, the scanned and cleaned email message is sent back to the recipient's email gateway. The recipient's email gateway receives the scanned and cleaned email message at block 610. This time, since the email message is cleaned, it does not need to be cleaned again and the process flows from block 615 to block 634 as described above. The process stops at block 635.

As can be appreciated, the system and method described in FIG. 5 and in FIG. 6 follow standard email protocols until email messages have reached the recipient's email gateway and thus can be easily implemented with minimal modification to the hardware and/or software of the sender's email server, the DNS server, and the recipient's email gateway.

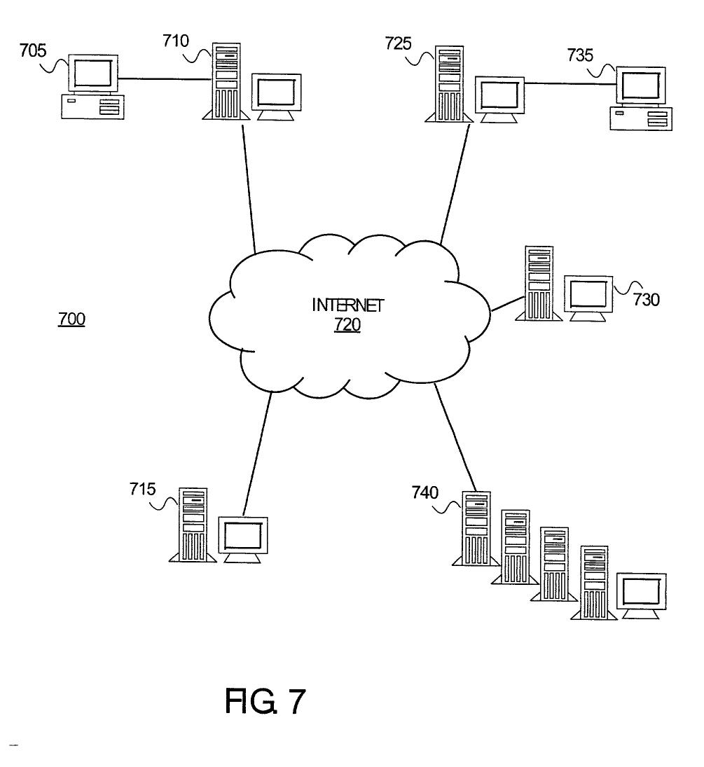

FIG. 7 is an exemplary network diagram illustrating one embodiment of an email scanning system including a group of email-scanning servers, a recipient's email gateway and a service provider's email server. In this situation, a service provider's email server is used by a recipient for email services. The service provider may be an Internet service provider (e.g., America Online, etc.) or any other service providers. When an email message is sent from a sender at sending device 705 to the recipient at receiving device 735, SMTP is used to transmit the email message to the sender's email server 710. The sender's email server 710 then makes a DNS query using DNS server 715 via the Internet 720 to determine a best path to route the email message to the recipient. The sender's email server 710 uses the Internet domain name in the recipient's email address, which is included in the email header for such a DNS query. In one embodiment, since the recipient does not own an Internet domain name and uses the service provider's Internet domain name, the sender's email server 710 obtains the IP address of the service provider's email server 730 as the best path to route the email message.

When the IP address of the service provider's email server 730 is determined, the sender's email server 710 establishes a TCP connection with the service provider's email server 730 via the Internet 720. When the connection is made, the email message is transmitted from the sender's email server 710 to the service provider's email server 730 using SMTP. The email message may travel through various routers (not shown) on the Internet 720 before arriving at the service provider's email server 730. The service provider's email server 730 may include a POP and/or IMAP server so that the email message can be stored therein.

The recipient's email gateway 725 may include a software agent configured to automatically retrieve email messages from the service provider's email server 730 at predetermined time intervals. When the email message is retrieved, the software agent may then transmit the email messages to a group of email-scanning servers 740 for virus detection and cleaning. The recipient's email gateway 725 may use a pre-configured IP address to locate the group of email-scanning servers 740, or it may use DNS to query for the IP address of the group of email-scanning servers 740.

When the group of email-scanning servers 740 receives the email message from the recipient's email gateway 725, the email messages are scanned and cleaned as previously described. The group of email-scanning servers 740 may add a header to the email message which includes status codes for identifying that the email message is scanned and cleaned for viruses. The status codes may also indicate that a virus was detected so that notification messages can be sent. For example, notification messages may be sent to the sender and to the recipient. The notification messages may also be sent to the email administrator. The notification messages may be used to locate the source of the virus to eliminate it.

The group of email-scanning servers 740 then transmits the scanned and cleaned email messages back to the recipient's email gateway 725. The IP address of the recipient's email gateway 725 may be obtained as described above. The recipient's email gateway 725 may then identify the email message as scanned and cleaned by checking the header added by the group of email-scanning servers 740. The recipient's email gateway 725 may include a Post Office Protocol (POP) and/or Internet Message Access Protocol (IMAP) server so that the clean email can be stored therein until requested by the recipient at receiving device 735. Alternatively, the group of email-scanning servers 740 may transmit the scanned and cleaned email messages to the service provider's email server 730.

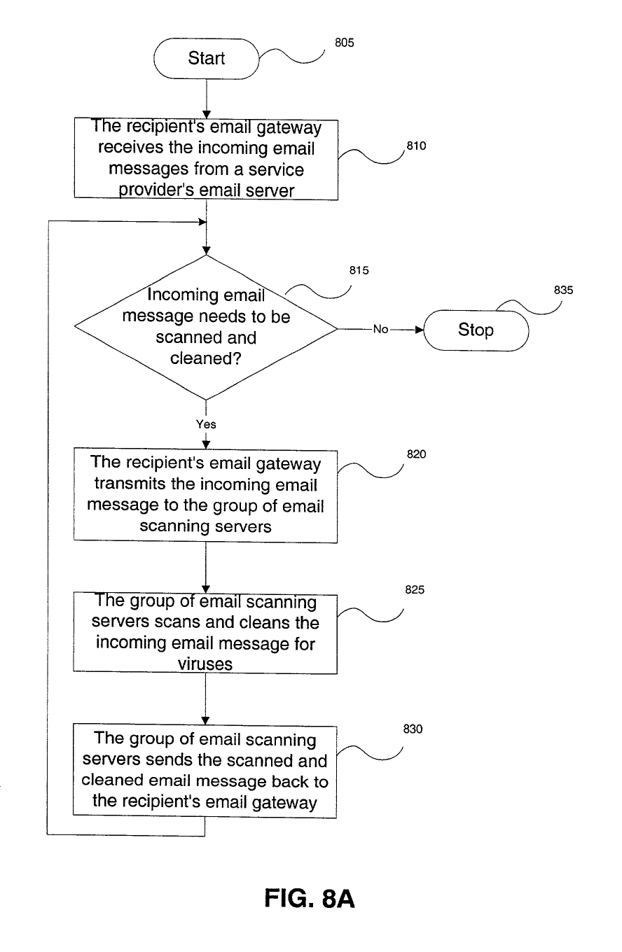

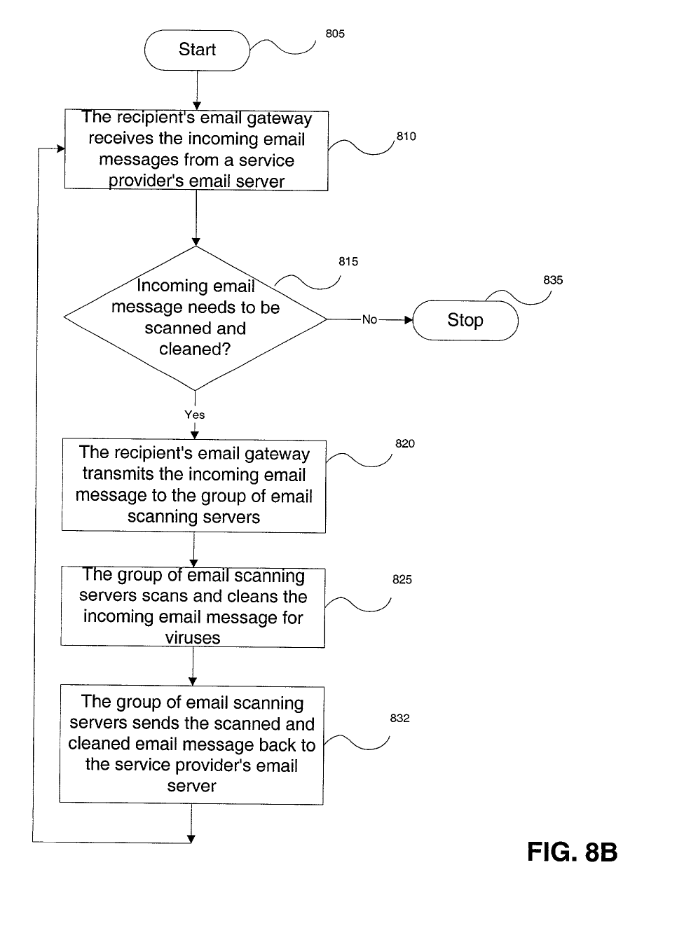

FIG. 8A is an exemplary flow diagram illustrating an email scanning process for a system having a group of email-scanning servers, a recipient's email gateway and a service provider's email server. The process starts at block 805. As described above, the email messages are transmitted from the sender's email server to the service provider's email server. At block 810, the email messages are retrieved from the service provider's email server at predetermined time intervals (e.g., 300 seconds) by the agent software in the recipient's email gateway. At block 815, a determination is made to see if the email message needs to be scanned and cleaned of potential viruses. As described above, the determination may be made by software resident in the recipient's email gateway based on the source of the incoming email message, or a status code in the header of the email message.

If the email message comes from the group of email-scanning servers or if the header of the email message contains a status code indicating that the email message is free of virus, the email message is stored in the recipient's email gateway and the process stops at block 835. However, if the email message comes from sources other than the group of email-scanning servers, or it does not contain a status code indicating that it is free of virus, the recipient's email gateway transmits the email message to the group of email-scanning servers, as shown in block 820. At block 825, the email message is scanned and cleaned by the group of email-scanning servers.

The operation performed in block 825 may include verification to see if the recipient is a subscriber to the virus scanning and cleaning service. If the recipient is not a subscriber, the email message reached the email server in error, and the email message may be bounced back to the sender. However, if the recipient is a subscriber, the email message is sent to a first email-scanning server in the group of email-scanning servers. Alternatively, it may not be necessary for the group of email-scanning servers to perform subscriber verification.

At block 830, the scanned and cleaned email message is sent back to the recipient's email gateway. This time, since the email message is cleaned, it does not need to be cleaned again, as determined by the operation in block 815. The process flows from block 815 to block 835 and stops at block 835.

FIG. 8B illustrates an alternative process from the process described in FIG. 8A. The two processes are similar until after the operations performed in block 825. Referring to FIG. 8B, after the operations in block 825 are completed, the group of email-scanning servers sends the scanned and cleaned email message to the service provider's email server (instead of to the recipient's email gateway as in FIG. 8A). From block 832, the process flows back to block 810 where the recipient's email gateway retrieves the email message from the service provider's email server as described above. However, since the email message is cleaned, it does not need to be cleaned again, as determined by the operation in block 815. The process flows from block 815 to block 835 and stops at block 835. Note that in the process described in FIG. 8B, there is no transmission of email message from the group of email scanning servers to the recipient's email gateway. Furthermore, the determination performed in block 815 of FIG. 8B may be based on the status code rather than based on the source of the email messages. This is because there is no guarantee that the email messages received from the service provider's email server have already been scanned and cleaned by the group of email-scanning servers.

As can be appreciated, the system and methods described in FIG. 7, FIG. 8A and FIG. 8B follow standard email protocols until email messages have reached the recipient's email gateway and thus can be easily implemented with minimal modification to the hardware and/or software of the sender's email server, the DNS server, and the service provider's email server. In addition, using the system and method described in FIG. 7 and FIG. 8A and FIG. 8B, the group of email-scanning servers 740 can easily support thousands of recipient's email gateways 725 to provide virus scanning and cleaning service. Furthermore, the recipient's email gateway 725 can be configured to support thousands of recipients with email services provided by multiple email service providers.

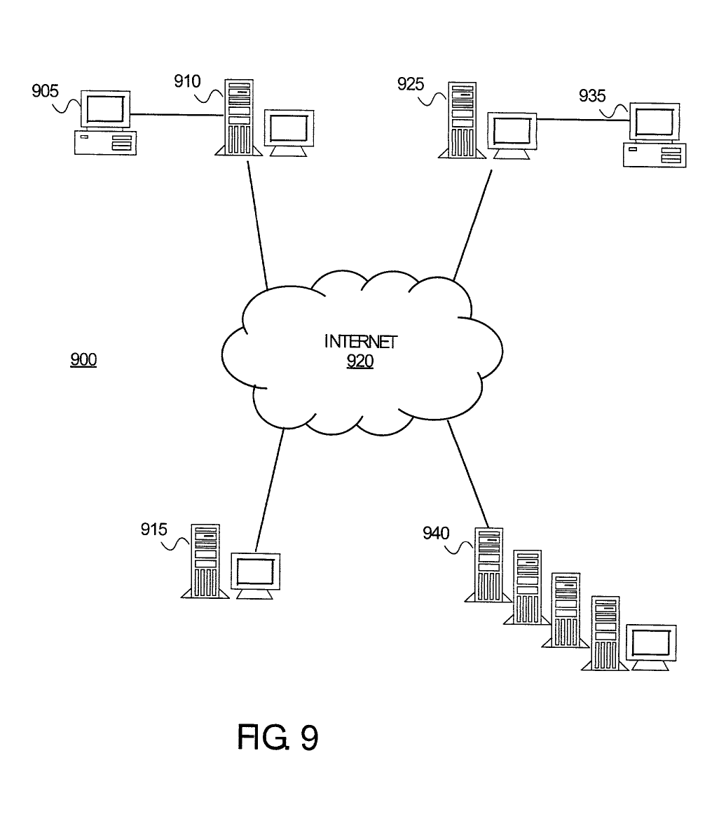

FIG. 9 is an exemplary network diagram illustrating one embodiment of an email scanning system including a group of email-scanning servers and a recipient's email gateway using dynamic IP addressing. When the recipient uses an Internet connection with a dynamic IP address, the recipient's email gateway may be used as an email server and the group of email-scanning servers may be used as an intelligent email relay server. Referring to FIG. 9, when an email message is sent from the sender at sending device 905 to the recipient at receiving device 935, SMTP is used to transmit the email message to the sender's email server 910. The sender's email server 910 then makes a DNS query using a DNS server 915 via the Internet 920 to determine the best path to route the email message. Conventionally, the DNS server 915 provides a static IP address of the recipient's email gateway 925. However, such a situation does not apply since the recipient's email gateway 925 uses a dynamic IP address.

In one embodiment, the DNS server 915 is pre-configured to provide the IP address of the group of email-scanning servers 940. When the IP address of the group of email-scanning servers 940 is identified, the sender's email server 910 establishes a TCP connection with the group of email-scanning servers 940 via the Internet 920. When the connection is made, the email message is transmitted from the sender's email server 910 to the group of email-scanning servers 940 using SMTP.

When the group of email-scanning servers 940 receives the email message, the email message is scanned and cleaned as described above. The group of email-scanning servers 940 may add a header to the email message, which may include a status code to identify that the email message is scanned and cleaned of viruses. The status codes may also indicate that a virus was detected so that notification messages can be sent. For example, notification messages may be sent to the sender and to the recipient. The notification messages may also be sent to the email administrator. The notification messages may be used to locate the source of the virus to eliminate it. In one embodiment, the group of email scanning-servers 940 stores the clean email messages in an email queue. For example, the email queue may be located on a storage device (e.g., a hard disk, etc.) coupled with the group of email-scanning servers 940.

In one embodiment, the recipient's email gateway 925 may include a software agent that monitors its Internet connection and keeps track of its dynamic IP address. Thus, when the IP address of the recipient's email gateway 925 changes, the software agent keeps track of such changes.

In another embodiment, at predetermined time intervals (e.g., 300 seconds) the software agent sends a “Forward Request” to the group of email-scanning servers 940. Included in the “Forward Request” message are the most current IP address and other pertinent data associated with the recipient's email gateway 925, as well as the recipient's Internet domain name or email address. In another embodiment, the software agent also includes codes for authentication of the “Forward Request” message such that forgery and fraud can be prevented.

The “Forward Request” message is transmitted from the recipient's email gateway 925 to the group of email-scanning servers 940 using a TCP connection. This indicates that the recipient's email gateway 925 is online and that its IP address is up to date when the group of email-scanning servers 940 receives the “Forward Request” message. In order to make such a TCP connection, the recipient's email gateway 925 may use a pre-configured IP address to locate the group of email-scanning servers 940. Alternatively, it may use DNS to query for the IP address of the group of email-scanning servers 940.

When the group of email-scanning servers 940 receives the “Forward Request” message, it then compares the recipient's Internet domain name or email address with the email messages stored in its email queue. When there are email messages for the recipient, the group of email-scanning servers 940 retrieves the clean email messages from the email queue and establishes a TCP connection with the recipients email gateway 925 using the IP address obtained from the “Forward Request”. The clean email messages are then transmitted to the recipient's email gateway 925. The recipient's email gateway 925 may include a Post Office Protocol (POP) and/or Internet Message Access Protocol (IMAP) server so that the clean email messages can be stored until accessed by the recipient.

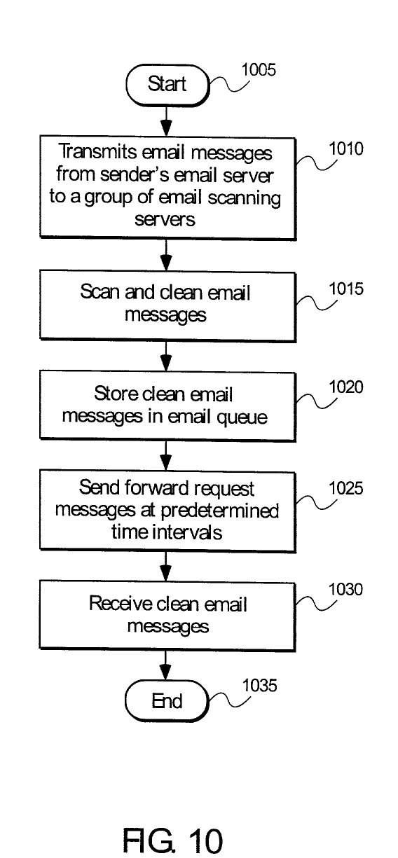

FIG. 10 is an exemplary flow diagram illustrating one embodiment of an email scanning process using a system including a group of email-scanning servers and a recipient's email gateway having a dynamic IP address. The process starts at block 1005. At block 1010, the email messages are transmitted from the sender's email server to the group of email-scanning servers. At block 1015, the email messages are scanned and cleaned of viruses. At block 1020, the clean email messages are stored in an email queue. At block 1025, “Forward Request” messages are sent to the group of email-scanning servers to request for the clean email messages. These “Forward Request” messages are sent at predetermined time interval (e.g., every 300 seconds) by the recipient's email gateway. At block 1030, the clean email messages are received at a recipient's email gateway and stored on behalf of the recipient. The process ends at block 1035.

The methods described herein may be stored in the memory of a computer system as a set of instructions (i.e., software). The set of instructions may reside, completely or at least partially, within the main memory and/or within the processor to be executed. In addition, the set of instructions to perform the methods described above could alternatively be stored on other forms of machine-readable media. For the purposes of this specification, the term “machine-readable media” shall be taken to include any media which is capable of storing or embodying a sequence of instructions for execution by the machine and that cause the machine to perform any one of the methodologies of the present invention. The term “machine readable media” shall accordingly be taken to include, but not limited to, optical and magnetic disks.

Alternatively, the logic to perform the methods as discussed above, could be implemented in additional computer and/or machine readable media, such as, for example, discrete hardware components as large-scale integrated circuits (LSI's), field programmable gate array (FPGA's), application-specific integrated circuits (ASIC's), firmware such as electrically erasable programmable read-only memory (EEPROM's), and electrical, optical, acoustical and other forms of propagated signals (e.g., carrier waves, infrared signals, digital signals, etc.), etc. For example, the logic in the software agent described with the recipient's email gateway may be implemented in hardware using read-only memory (ROM).

From the above description and drawings, it will be understood by those of ordinary skill in the art that the particular embodiments shown and described are for purposes of illustration only and are not intended to limit the scope of the invention. Those of ordinary skill in the art will recognize that the invention may be embodied in other specific forms without departing from its spirit or essential characteristics. References to details of particular embodiments are not intended to limit the scope of the claims.

I claim:

1. A system, comprising:
a recipient's email gateway connected to a network and configured to receive email messages from the network; and
a group of email-scanning servers comprising one or more email scanning servers, each of the email-scanning servers configured with anti-virus software to scan and clean viruses, the group of email scanning servers connected to the network,
wherein when the recipient's email gateway receives an email message from the network, the email message is transmitted to the group of email-scanning servers to generate a clean email message using the anti-virus software, and
wherein the clean email message is transmitted by the group of email-scanning servers to the recipient's email gateway.

2. The system of claim 1, wherein the email message is transmitted from the recipient's email gateway to the group of email-scanning servers after the email message is verified to determine if the email message needs to be scanned and cleaned.

3. The system of claim 2, wherein the email message is verified by determining source of the email message, wherein when the source of the email message is the group of the email-scanning servers, the email message has already been scanned and cleaned.

4. The system of claim 2, wherein the email message is verified by checking a status code in a header of the email message, wherein after the group of the email-scanning servers scan and clean the email message, the status code is updated.

5. The system of claim 1, wherein the email message is transmitted from the recipient's email gateway to the group of email-scanning servers using a pre-configured IP address of the group of email-scanning servers or using a DNS server connected to the network to determine an IP address of the group of email-scanning servers.

6. The system of claim 1, wherein the group of email-scanning servers includes incoming email processing logic to receive the email message to be scanned and cleaned and outgoing email processing logic to transmit the clean email message.

7. The system of claim 6, wherein the group of email-scanning servers further includes subscriber verification processing logic to determine if the email message belongs to a recipient who is a subscriber to an email scanning and cleaning service performed by the group of email-scanning servers.

8. The system of claim 1, wherein each email-scanning server in the group of email-scanning servers comprises one or more anti-virus software.

9. The system of claim 1, wherein the recipient's email gateway includes email server processing logic.

10. The system of claim 1, further comprising a recipient's email server coupled with the recipient's email gateway and connected to the network, wherein after the recipient's email gateway receives the clean email messages from the group of email-scanning servers, the recipient's email gateway transmits the clean email messages to the recipient's email server.

11. The system of claim 1, wherein the recipient's email gateway is further configured to receive the email messages from a service provider's email server.

12. A method, comprising:
receiving incoming email messages from a network;
transmitting the incoming email messages to a group of email scanning servers comprising one or more email-scanning servers, the group of scanning servers connected to the network, each of the email-scanning servers configured with one or more anti-virus software to scan and clean viruses, wherein the incoming email messages are scanned and cleaned by the group of email-scanning servers to generate clean email messages; and
receiving the clean email messages from the group of email scanning servers.

13. The method of claim 12, further comprising verifying the incoming email messages to determine if the incoming email messages need to be scanned and cleaned.

14. The method of claim 13, wherein verifying comprises checking a source of the incoming email messages, and wherein when the source of the incoming email messages is the group of email-scanning servers, the incoming email messages are clean.

15. The method of claim 13, wherein verifying comprises checking a status code in the headers of the incoming email messages, wherein the group of email-scanning servers updates the status code of the incoming email messages after the incoming email messages have been scanned and cleaned.

16. The method of claim 12, wherein the incoming email messages are transmitted to the group of email-scanning servers using a pre-configured Internet protocol (IP) address of the group of email-scanning servers or by using a domain name system (DNS) to determine IP address of the group of email-scanning servers.

17. The method of claim 12, wherein the group of email-scanning servers is further configured to determine if the incoming email messages belong to recipient subscribers whose email messages are to be scanned and cleaned.

18. The method of claim 12, further comprising transmitting the clean email messages to a recipient's email server connected to the network

19. The method of claim 12, wherein receiving the incoming email message from the network comprises receiving the incoming email message from a service provider's email server connected to the network.

20. A computer readable medium containing executable instructions which, when executed in a processing system, causes the processing system to perform the steps of a method comprising:
receiving incoming email messages from a network;
transmitting the incoming email messages to a group of email scanning servers comprising one or more email-scanning servers, the group of scanning servers connected to the network, each of the email-scanning servers configured with one or more anti-virus software to scan and clean viruses, wherein the incoming email messages are scanned and cleaned by the group of email-scanning servers to generate clean email messages; and
receiving the clean email messages from the group of email scanning servers.

21. The computer readable medium of claim 20, further comprising verifying the incoming email messages to determine if the incoming email messages need to be scanned and cleaned.

22. The computer readable medium of claim 21, wherein verifying comprises checking a source of the incoming email messages, and wherein when the source of the incoming email messages is the group of email-scanning servers, the incoming email messages are clean.

23. The computer readable medium of claim 21, wherein verifying comprises checking a status code in the headers of the incoming email messages, wherein the group of email-scanning servers updates the status code of the incoming email messages after the incoming email messages have been scanned and cleaned.

24. The computer readable medium of claim 20, wherein the incoming email messages are transmitted to the group of email-scanning servers using a pre-configured Internet protocol (IP) address of the group of email-scanning servers or by using a domain name system (DNS) to determine IP address of the group of email-scanning servers.

25. The computer readable medium of claim 20, wherein the group of email-scanning servers is further configured to determine if the incoming email messages belong to recipient subscribers whose email messages are to be scanned and cleaned.

26. The computer readable medium of claim 20, further comprising transmitting the clean email messages to a recipient's email server connected to the network.

27. The computer readable medium of claim 20, wherein receiving the incoming email message from the network comprises receiving the incoming email message from a service provider's email server connected to the network.

28. A system, comprising:
a service provider's email server connected to a network and configured to receive email messages from the network;
a recipient's email gateway coupled with the service provider's email server and connected to the network, the recipient's email gateway configured to retrieve the email messages from the service provider's email server at predetermined time periods; and
a group of email-scanning servers comprising one or more email scanning servers, each of the email-scanning servers includes anti-virus software to scan and clean viruses, the group of email-scanning servers connected to the network,
wherein when the recipient's email gateway retrieves the email messages from the service provider's email server, the email messages are transmitted to the group of email-scanning servers to generate clean email messages.

29. The system of claim 28, wherein the clean email messages are transmitted by the group of email-scanning servers to the recipient's email gateway or to the service provider's email server.

30. The system of claim 28, wherein the email message is transmitted from the recipient's email gateway to the group of email-scanning servers after the email message is verified to determine if the email message needs to be scanned and cleaned.

31. The system of claim 30, wherein the email message is verified by checking a status code in a header of the email message, wherein after the group of the email-scanning servers scan and clean the email message, the status code is updated.

32. The system of claim 28, wherein the email message is transmitted from the recipient's email gateway to the group of email-scanning servers using a pre-configured IP address of the group of email-scanning servers or using a DNS server connected to the network to determine an IP address of the group of email-scanning servers.

33. The system of claim 28, wherein the group of email-scanning servers includes incoming email processing logic to receive the email message to be scanned and cleaned and outgoing email processing logic to transmit the clean email message.

34. The system of claim 33, wherein the group of email-scanning servers further includes subscriber verification processing logic to determine if the email message belongs to a recipient who is a subscriber to an email scanning and cleaning service performed by the group of email-scanning servers.

35. The system of claim 28, wherein each email-scanning server in the group of email-scanning servers comprises one or more anti-virus software.

36. The system of claim 28, wherein the recipient's email gateway includes email server processing logic.

37. The system of claim 28, further comprising a recipient's email server coupled with the recipient's email gateway and connected to the network, wherein after the recipient's email gateway receives the clean email messages from the group of email-scanning servers, the recipient's email gateway transmits the clean email messages to the recipient's email server.

38. A method, comprising:
retrieving incoming email messages from a service provider's email server at predetermined time intervals, the service provider's email server receiving the incoming email messages from a network;
transmitting the incoming email messages to a group of email scanning servers comprising one or more email-scanning servers, the group of scanning servers connected to the network, each of the email-scanning servers includes one or more anti-virus software to scan and clean viruses, wherein the incoming email messages are scanned and cleaned by the group of emailed-scanning servers to generate clean email messages; and
receiving the clean email messages from the group of email scanning servers.

39. The method of claim 38, further comprising verifying the incoming email messages to determine if the incoming email messages need to be scanned and cleaned.

40. The method of claim 39, wherein verifying comprises checking source of the incoming email messages, and wherein when the source of the incoming email messages is the group of email-scanning servers, the incoming email messages are clean.

41. The method of claim 39, wherein verifying comprises checking a status code in the headers of the incoming email messages, wherein the group of email-scanning servers updates the status code of the incoming email messages after the incoming email messages have been scanned and cleaned.

42. The method of claim 38, wherein the incoming email messages are transmitted to the group of email-scanning servers using pre-configured Internet protocol (IP) address of the group of email-scanning servers or by using a domain name system (DNS) to determine IP address of the group of email-scanning servers.

43. The method of claim 38, wherein the group of email-scanning servers is further configured to determine if the incoming email messages belong to recipient subscribers whose email messages are to be scanned and cleaned.

44. A system, comprising:
a sender's email server connected to a network;
a group of email-scanning servers comprising one or more email scanning servers, each of the email-scanning servers includes one or more anti-virus software to scan and clean viruses, the group of email-scanning servers connected to the network, the sender's email gateway transmitting the email messages to the group of email-scanning servers to scan and clean the email messages to generate clean email messages, wherein the clean email messages are stored in an email queue coupled with the group of email-scanning servers; and
a recipient's email gateway connected to the network, the recipient's email gateway configured to send forward requests to the group of email-scanning servers at predetermined time intervals, wherein when the forward requests are received, the clean email messages are transmitted from the email queue to the recipient's email gateway.

45. The system of claim 44, wherein the recipient's email gateway uses dynamic Internet protocol (IP) addressing.

46. The system of claim 45, wherein the recipient's email gateway monitors its dynamic IP address and stores the dynamic IP address when it changes.

47. The system of claim 44, wherein the recipient's email gateway sends forward requests to the group of email-scanning servers using a pre-configured IP address of the group of email-scanning servers or using an IP address provided by a data name system (DNS) connected to the network.

48. The system of claim 47, wherein the forward requests are sent at predetermined time intervals.

49. The system of claim 44, wherein authentication information is sent with the forward requests.

50. The system of claim 44, wherein the forward request comprises a dynamic IP address of the recipient's email gateway and email address of a recipient.

51. The system of claim 50, wherein the email address or Internet domain name of the recipient is used to identify the clean email messages stored in the email queue to be retrieved.

52. The system of claim 44, wherein the group of email-scanning servers includes incoming email processing logic to receive the email message from the sender's email server and outgoing email processing logic to transmit the clean email message to the recipient's email gateway.

53. The system of claim 44, wherein the group of email-scanning servers further includes subscriber verification processing logic to determine if the email message belongs to a recipient whose email messages are to be scanned and cleaned.

54. A method, comprising:
sending email messages from a sender's email server to a group of email-scanning servers using a network, the group of email scanning servers comprising one or more email scanning servers having one or more anti-virus software to scan and clean viruses;
scanning and cleaning the email messages to generate clean email messages;
storing the clean email messages in an email queue; and
responsive to receiving forward requests from a recipient's email gateway, transmitting the clean email messages from the email queue to a recipient's email gateway.

55. The method of claim 54, wherein the forward requests comprises a dynamic Internet protocol (IP) address of the recipient's email gateway.

56. The method of claim 55, wherein the forward requests further comprises an email address or Internet domain name of a recipient.

57. The method of claim 56, wherein the email address or Internet domain name of the recipient is used to determine the clean email messages stored in the email queue to be transmitted to the recipient's email gateway.

58. The method of claim 54, wherein the forward requests are sent at predetermined time interval.
